(19) United States
(12) Patent Application Publication
(10) Pub. No.: US 2012/0263630 A1
(43) Pub. Date: Oct. 18, 2012

(54) VERTICAL HIGH TEMPERATURE AND HIGH PRESSURE STOVE STRUCTURE

(76) Inventors: Zhi HE, New Taipei City (TW); Xiao-Yu Hu, New Taipei City (TW)

(21) Appl. No.: 13/444,243

(22) Filed: Apr. 11, 2012

(30) Foreign Application Priority Data
Apr. 12, 2011 (TW) 100206322

(51) Int. Cl. B01J 19/00

(52) U.S. Cl. 422/208

(57) ABSTRACT

A vertical high temperature and high pressure stove structure includes a vertically-disposed pressure vessel and a heating module disposed in the pressure vessel. The heating module includes a heating space filled with a quartz tube and sets of independent heating units. The independent heating units includes a lower protective zone heating unit, a provision zone heating unit, a synthesis zone heating unit and an upper protective zone heating unit. The synthesis zone heating unit provides a group III element fusion zone with a temperature equal to or greater than that of a composition melting point, the provision zone heating unit provides a steam having temperature greater than evaporation temperature to a group V element provision zone, and a compound synthesis of a group III element and a group V element as chemical element periodic table is rapidly completed in the group III element fusion zone.

### BACKGROUND OF THE INVENTION

1. Field of the Invention

The present invention relates to a synthesis facility for synthesizing group III-V compound.

2. Description of the Related Art

In rapid development of group III-V compound semiconductors in photoelectric industries, the demand of group III-V compound is to be steadily increased. Taking indium phosphide of group III-V compound for example, due to indium phosphide having dissociation pressure of 2.75 Mpa at its fusing point temperature, it is difficult to perform direct synthesis and crystal growth process in the single crystal stove. In view of this, it is generally high purity phosphorus and high purity indium are preliminarily synthesize in a high pressure stove, and then the synthesized compounds are placed in the single crystal stove for crystal growth. At present, several synthesis methods for synthesizing high purity indium phosphide polycrystalline are disclosed.

For example, ‘Synthesis, solute diffusion method or solute solution diffusion (SSD) method’ is the earliest method provided for synthesizing gallium phosphide, and after that the SSD method is applied to synthesize indium phosphide. As shown in FIG. 5, a basic framework of a diffusion facility for a conventional solute diffusion method and synthesis temperature distribution thereof are illustrated, and this diffusion facility is related to deal with a diffusive synthesis at a temperature less than the fusing point temperature of indium phosphide. In the basic framework of the diffusion facility, a crucible 51 formed with an upwardly-formed opening is disposed in a sealed quartz tube 50 at a predetermined height, the sealed quartz tube 50 is disposed in a high temperature stove 55, and phosphorus and indium are placed in the sealed quartz tube 50. Phosphorus steam of less than one atmospheric pressure is formed when the bottom phosphorus in the quartz tube 50 is heated to a particular temperature, and the phosphorus steam is gradually diffused to indium located in the crucible until indium is saturated. Due to temperature ingredient of the indium molten liquid, phosphorus diffused to indium begins to precipitate indium phosphide when being oversaturated at low-temperature zone. The conventional solute diffusion method has advantages of low-temperature synthesis, effective to control silicon contamination in the quartz vessel, high purity indium phosphide, and up to the standard of carrier ion concentration of 10¹⁴ cm⁻³. However, the conventional solute diffusion method has disadvantages of low synthesis rate caused by low diffusion velocity in indium phosphide and low productivity below the standard. Moreover, due to the very low synthesis temperature in the conventional solute diffusion method, component proportion of phosphorus and indium cannot be guaranteed, and rich indium tends to be formed in the synthesized polycrystalline.

‘Horizontal Bridgman (HB) method’ and ‘Horizontal Gradient Freeze (HGF) method’ are two conventional examples, which utilize phosphorus steam and indium molten mass formed at indium phosphide melting point to perform the synthesis process in a horizontal stove, as shown in FIG. 6. In the HB and HGF methods, a horizontal three-zone high temperature and high pressure stove is applied, and the basic framework of this high temperature and high pressure stove includes a horizontal quartz pipe 60, a crucible 61 disposed on one end of the quartz pipe 60 and provided with an upwardly-formed opening, and a high temperature stove 65 outwardly disposed around the quartz pipe 60 and provided with two heating body 66 and 67 and a radiofrequency coil 68. In correspondence to the quartz pipe 60, the heating body 66 and 67 and the radiofrequency coil 68 are respectively formed with an indium melting zone, a indium phosphide synthesis zone and a phosphorus steam control zone, thus to increase precision and stability of temperature control. When a high purity indium placed in the quartz pipe 60 or the crucible 61 is located at one end of the quartz pipe 60 and a high purity red phosphorus is placed on the other end of the quartz pipe 60, the quartz pipe 60 is sealed and filled with an inert gas so that the inner pressure of the quartz pipe 60 is slightly greater than the outside pressure thereof. According to the molten rate of the phosphorus steam, the phosphorus steam is fused in the indium molten mass from one side of the quartz pipe 60, thus to complete the synthesis. In the HB or HGF method, the indium molten mass is characterized with a high temperature and a large contact surface and, and therefore the synthesis rate of the HB or HGF method is greater than that of the SSD method. Further, in the techniques of the HB or HGF method for producing high purity indium phosphide polycrystalline, the important control parameters includes indium molten mass temperature, phosphorus steam pressure, controls of mobile rate of the crucible 51, synthesis zone temperature and settings of synthesis mixture proportion. When the temperature of the indium molten mass is increased, the molten rate of indium to phosphorus is increased. Therefore, the formation of the rich indium is relatively reduced, but silicon contamination tends to be formed due to high temperature. Alternatively, the condition of the silicon contamination can be improved by using pyrolytic boron nitride (pBN) crucibles, but the pBN crucible needs a higher cost. Furthermore, when the phosphorus steam pressure is increased, the formation of the rich indium is relatively decreased, but tube explosion caused by phosphorus is possibly occurred. It shall be careful in the control process. Moreover, when the temperature of the synthesis temperature distribution is increased, the synthesis rate can be rapidly increased, but the contamination is possibly occurred. Note that complication and difficulty of the synthesis are increased if pressure, temperature and the crucible need to be precisely calculated and adjusted, thus to reduce the synthesis efficiency and the synthesis productivity below the standard.

That is to say, the current synthesis facilities for high purity indium have the problems of high technique requirement, high cost and high contamination and danger of tube explosion caused by phosphorus, and therefore the synthesis efficiency and the synthesis productivity cannot be effectively increased.

### BRIEF SUMMARY OF THE INVENTION

In view of this, the main purpose of the present invention is to provide a low-cost vertical high temperature and high pressure stove structure

For realizing the purposes, functions and effects above, the present invention adopts the following technical projects. A vertical high temperature and high pressure stove structure of the present invention at least includes a pressure vessel vertically disposed on a land surface and a heating module disposed in the pressure vessel. The heating module includes a heating space filled with a quartz tube and at least four sets of independent heating units corresponding to the heating space. The at least four sets of independent heating units of the heating module are bottom-up sequentially defined as a lower protective zone heating unit, a provision zone heating unit, a synthesis zone heating unit and an upper protective zone heating unit.

With the concrete realization of technical projects above, the present invention provides the following functions and effects.

In the vertical high temperature and high pressure stove structure, the synthesis zone heating unit of the heating module provides a group III element fusion zone with a temperature equal to or greater than that of a composition melting point, the provision zone heating unit of the heating module provides a steam having temperature greater than evaporation temperature to a group V element provision zone, and a compound synthesis of a group III element and a group V element as chemical element periodic table is rapidly completed in the group III element fusion zone. Further, due to cost-effective facilities, rapid synthesis rate and indium phosphide having less rich indium generated, the synthesis efficiency of the present invention can be effectively increased. Besides, due to precise usage quantity of red phosphorus in the synthesis process and low-cost facilities, it is cost-effective and suitable of providing optimistic feeding pattern in the single crystal growth method.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view showing configuration and arrangement of a vertical high temperature and high pressure stove structure of the present invention;

FIG. 2 is a schematic view showing a flow chart of a compound synthesis method of a vertical high temperature and high pressure stove of the present invention;

FIG. 3 is a schematic view showing a simplified framework of a vertical high temperature and high pressure stove structure of the present invention

FIG. 4 is a schematic diagram showing temperature distribution of compound synthesis performed in a vertical high temperature and high pressure stove;

FIG. 5 is a schematic view showing a facility framework of a conventional solute diffusion method and synthesis temperature distribution thereof; and

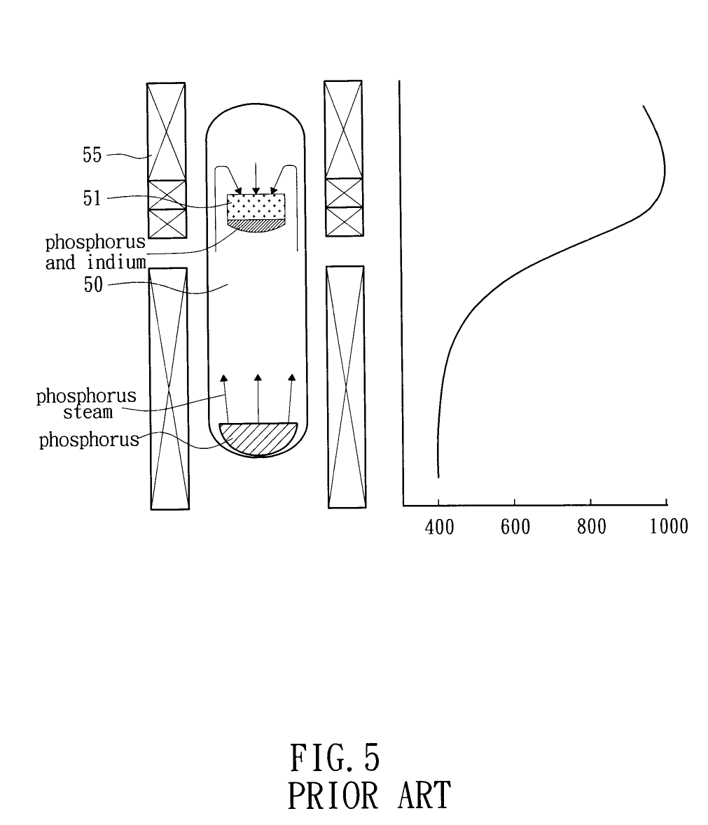

FIG. 6 is a schematic view showing a facility framework of a conventional Horizontal Bridgman method and synthesis temperature distribution thereof.

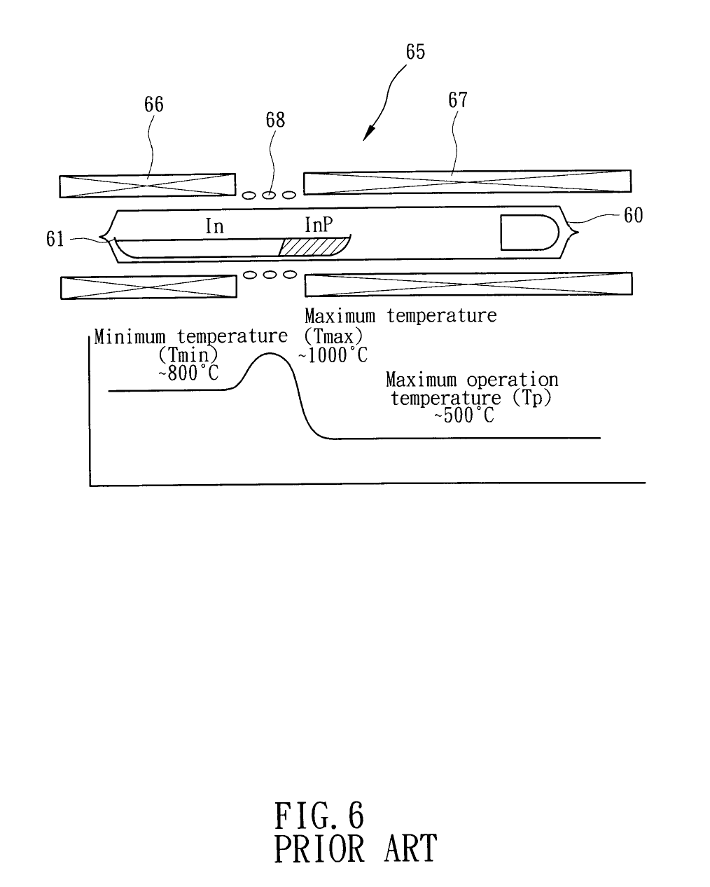

### DETAILED DESCRIPTION OF THE INVENTION

The present invention provides a vertical high temperature and high pressure stove structure, capable of completing a crystal growth of direct compound synthesis of a group III element and a group V element as chemical element periodic table in a high temperature and high pressure environment, such as group III-V compound comprising gallium arsenide, gallium phosphide or indium phosphide. In this embodiment, the group III-V compound is indium phosphide.

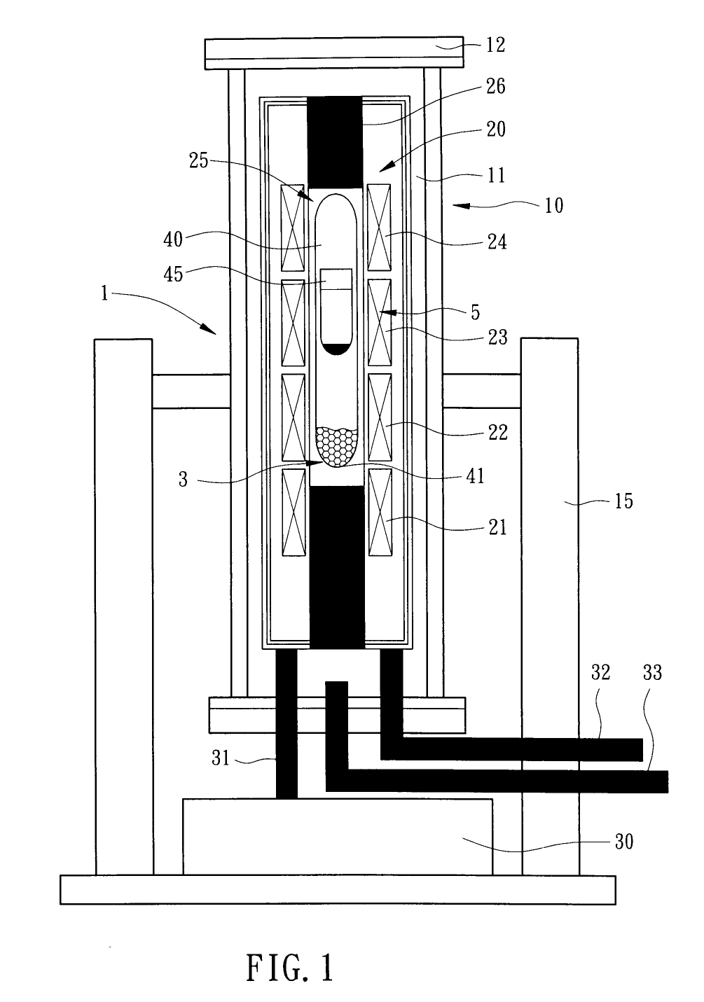

Under protection of high pressure, a vertical high temperature and high pressure stove 1 is capable of providing a group III element fusion zone 3 or synthesis zone with a temperature equal to or greater than that of a composition melting point, providing a group V element provision zone 5 to be located under the group III element fusion zone 3, and providing steam to the group III element fusion zone 3 at a temperature greater than evaporation temperature, and the direct synthesis is rapidly completed in the group III element fusion zone 3. In a preferred embodiment and a simplified structure shown in FIG. 1, the vertical high temperature and high pressure stove 1 of the present invention at least comprises a pressure vessel 10, a heating module 20 and a control module 30.

The pressure vessel 10 comprises a vessel main body 11 which is provided with an upwardly-formed opening and a top end disposed with a selectively-closed vessel cover body 12. The vessel main body 11 of the pressure vessel 10 is disposed on the land surface by a supporting frame 15. When the vessel main body 11 of the pressure vessel 10 is covered by the vessel cover body 12, the assembly of the vessel main body 11 of the pressure vessel 10 and the vessel cover body 12 capable of bearing 300 atmospheric pressure can be filled with high pressure gas therein, and an industrial nitrogen gas is served as a pressure medium to provide a high pressure operation environment and protect the vertical high temperature and high pressure stove 1.

The heating module 20 disposed in the vessel main body 11 of the pressure vessel 10 includes a heating space 25 formed with an upwardly-formed opening, and the opening of the heating space 25 of the heating module 20 is disposed with a core cover body 26 of selectable opening or closing. The quartz tube 40 of synthesis elements is filled in the heating space 25 of the heating module 20. In this embodiment, the maximum operation temperature of the heating module 20 is designed at 1400 C, and the heating space 25 of the heating module 20 is selectably designed with a variable diameter so as to grow polycrystalline with different sizes. Besides, the heating module 20 further includes at least or more than four sets of independent heating units 21, 22, 23 and 24 which are simultaneously corresponded to the heating space 25. In this embodiment, the amount of the independent heating units is four sets. The four sets of independent heating units 21, 22, 23 and 24 of the heating module 20 are bottom-up sequentially defined as a lower (first) protective zone heating unit 21, a provision zone heating unit 22, a synthesis zone heating unit 23 and an upper (second) protective zone heating unit 24. The provision zone heating unit 22 and the synthesis zone heating unit 23 are respectively corresponded to the group III element fusion zone 3 and the group V element provision zone 5 of the vertical high temperature and high pressure stove 1. The lower protective zone heating unit 21 and the upper protective zone heating unit 24 are utilized to stabilize the internal temperature of the heating module 20 for temperature protection. Further, the provision zone heating unit is utilized to provide the group V element (e.g., red phosphorus) with an accurate gasification temperature in favor of pressure control. The crystal growing zone heating unit is utilized to provide the group III element and the group V element (e.g., synthesis of phosphorus and indium) with sufficient and stable temperature for direct synthesis and crystal growth. Furthermore, if the amount of sets of the heating units 21, 22, 23 and 24 of the heating module 20 is greater than four, the amount of the provision zone heating unit 22 and the amount of the synthesis zone heating unit 23 are multiply increased in proportion to the amount of the heating units 21 of the heating module 20 so as to form six or eight sets of independent heating units 21, 22, 23 and 24 to increase precision and stability of temperature control to the group III element fusion zone 3 and the group V element provision zone and to provide a preferred high temperature operation environment.

Further, the pressure vessel 10 and the heating module 20 are connected to a control module 30, so that the control module 30 is capable of controlling the pressure and temperature of the pressure vessel 10.

The control module 30 includes a power cord 31 connected to the heating module 20 disposed in the pressure vessel 10, a temperature control signal line 32 and a high pressure pipe 33 utilized to fill a high pressure gas in the pressure vessel 10. The control module 30 is provided to control the pressure of the pressure vessel 10 and the temperature of the heating module 20 according to the requirement of a compound synthesis flow process. Besides, the control module 30 can perform the synthesis control of the pressure vessel 10 and the heating module 20 according to a predetermined time-variant control process which is programmed with preset temperature and pressure.

Accordingly, the formed vertical high temperature and high pressure stove structure has advantages of low cost, rapid production and in-situ synthesis and growth.

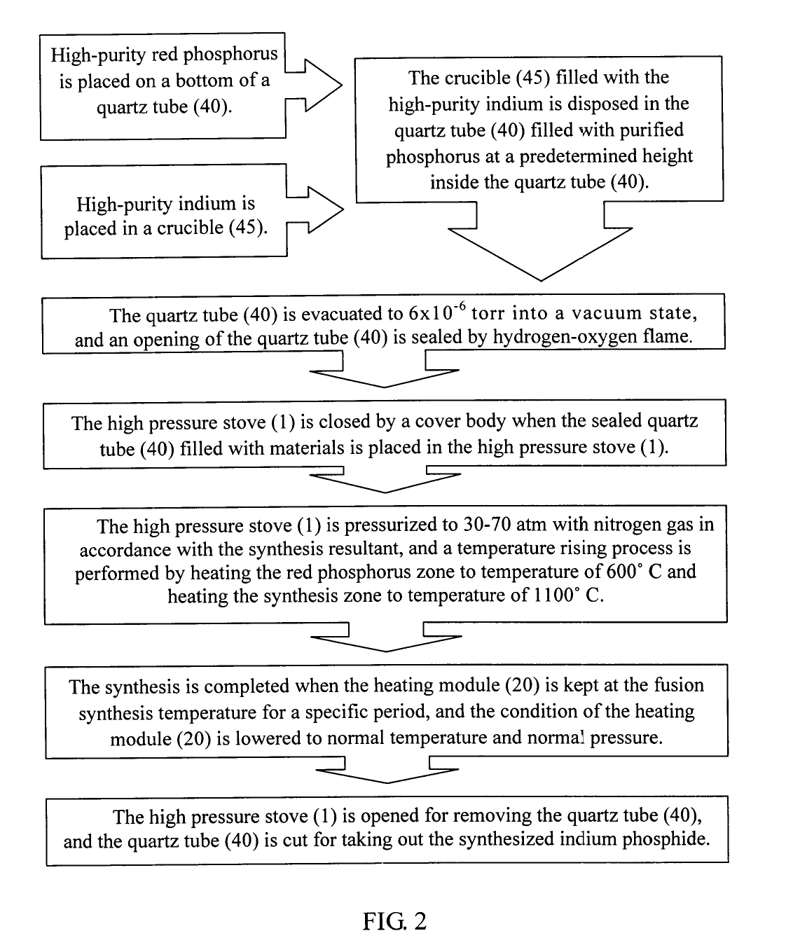

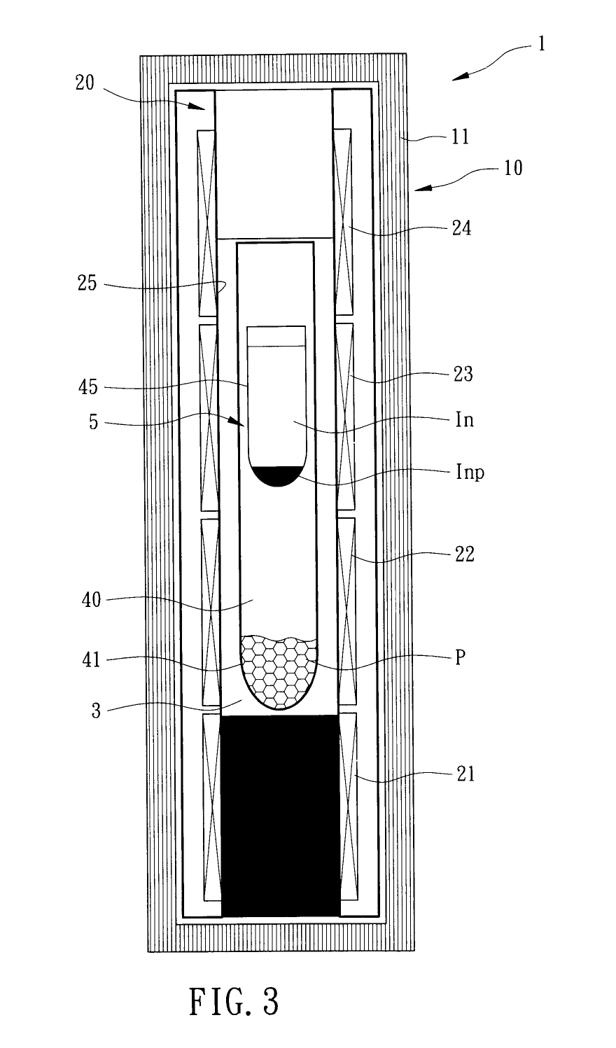

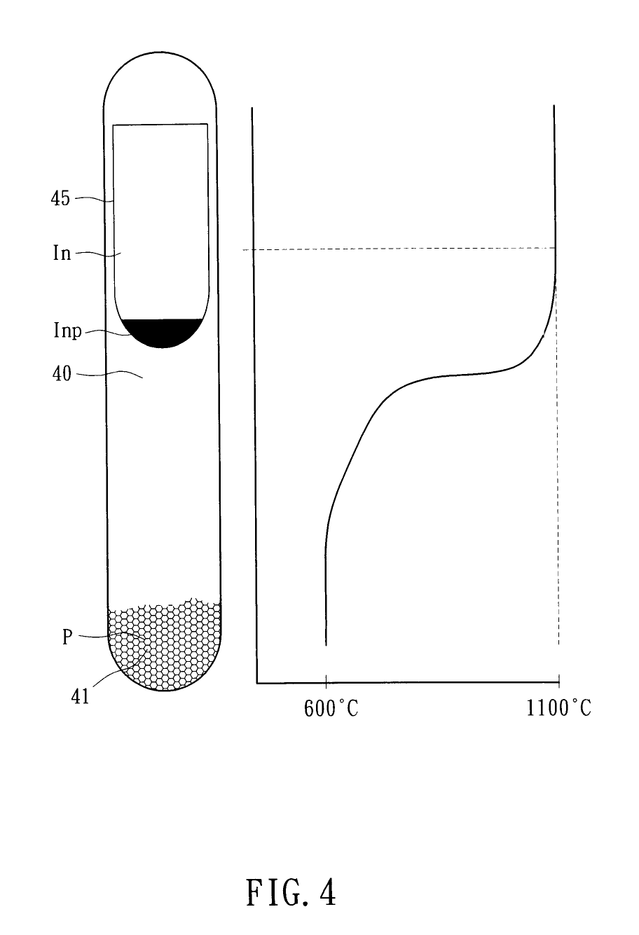

As shown in FIGS. 2, 3 and 4, the vertical high temperature and high pressure stove structure of the present invention for actual synthesis comprises the steps of:

a) a step of filling the group V element (e.g., red phosphorus), in which a high purity group V element is placed on a bottom 41 of a quartz tube 40;

b) a step of filling the group III element, in which a high purity group III element is then placed in a pyrolytic boron nitride (pBN) crucible 45;

c) a step of filling the group III element in the quartz tube 40, in which the pBN crucible 45 filled with the crystal seed and the high purity group III element is disposed in the quartz tube 40 filled with the group V element at a predetermined height inside the quartz tube 40;

d) a step of evacuating the quartz tube 40, in which the quartz tube 40 is evacuated to 6×10⁻⁶ torr into a vacuum state, and an opening of the quartz tube 40 is sealed by hydrogen-oxygen flame;

e) a step of filling the quartz tube 40 in a pressure vessel 10, in which when the sealed quartz tube 40 filled with the group III element and the group V element is placed in the heating space 25 of the heating module 20 which is disposed in the pressure vessel 10 of the vertical high temperature and high pressure stove 1, the pressure vessel 10 and the heating module 20 of the vertical high temperature and high pressure stove 1 are closed;

f) a step of pressurizing and heating to a fusion synthesis temperature, in which, with a high pressure nitrogen gas, the pressure vessel 10 of the vertical high temperature and high pressure stove 1 is pressurized to 30-70 atm according to the synthesis resultant, a temperature rising of a heating module 20 is performed that the heating module 20 is heated to a gasification temperature of the group V element (e.g., 600 C for red phosphorus) in correspondence to a heating unit of the group V element provision zone 5 and is heated to the fusion synthesis temperature of the group III element fusion zone 3 (e.g., indium for 1100 C) in the synthesis zone heating unit 23 of the group III element fusion zone 3 in correspondence to the group III element fusion zone 3;

g) a step of releasing pressure and temperature, in which the synthesis of the group III element and the group V element is completed when the heating module 20 is kept at the fusion synthesis temperature for a specific period, the temperature of the heating module 20 is finally lowered to normal temperature and the high pressure of the pressure vessel 10 is finally lowered to normal pressure, so that the synthesis of the group III element and the group V element is completed; and

h) a step of removing polycrystalline after the compound synthesis is completed, in which after the synthesis of the group III element and the group V element are completed, the vessel main body 11 and the heating module 20 are opened for removing the quartz tube 40, and the quartz tube 40 is cut for taking out the polycrystalline (e.g., indium phosphide polycrystalline).

According to the above description, it is understood that, when indium phosphide is synthesized by the vertical high temperature and high pressure stove structure of the present invention, the high purity red phosphorus up to 6N which is placed on the bottom 41 of the quartz tube 40 with one closed end is served as the group V element provision zone 5, and the high purity indium up to 6N which is placed on the pBN crucible 45 and the quartz tube 40 is served as the group III element fusion zone 3. When the sealed, vacuum-evacuated quartz tube 40 is vertically disposed in the heating module 20 of the pressure vessel 10 of the vertical high temperature and high pressure stove 1, further incorporated with temperature and pressure rising controls of the control module 30, the pressure vessel 10 is boosted by the nitrogen gas to obtain a final pressure according to the different synthesis resultant. Further, with the temperature of the group III element fusion zone 3 gradually increased to 1100 C and the temperature of the group V element provision zone 5 gradually increased to 600 C, the high purity indium phosphide, the high purity indium phosphide can be obtained by the phosphorus steam function and the contact reaction of high temperature fusion indium, i.e., indium can be completely synthesized into indium phosphide when the heating module 20 is kept at the fusion synthesis temperature for the specific period, thus to complete the growth of indium phosphide polycrystalline.

A successfully-completed indium phosphide polycrystalline is free of pore, redundant indium and surface oxidation. With the crucibles 45 of different diameters, a polycrystalline bar formed of corresponded diameter (e.g., 50 mm and 75 mm) and maximum length of 100 mm can be obtained. In Table (A), the result of the impurity content of polycrystalline bar tested by GDMS method is presented. The tested result also includes carrier ion concentration of 3×10¹⁵−1×10¹⁶ cm⁻³ and electron mobility of 3700-4500 cm², compared to general grain size of 5-10 mm².

TABLE (A)

| Element | ppb at | Element | ppb at | Element | ppb at | Element | ppb at | Element | ppb at |
|---|---|---|---|---|---|---|---|---|---|
| Li | 23 | Ca | <5 | Y | <0.1 | Ba | <0.1 | Hf | <0.1 |
| Be | <1 | Sc | <0.1 | Zr | <0.1 | La | <0.1 | Ta | <50* |
| B | 1.3 | Ti | <0.1 | Nb | <5 | Ce | <0.1 | W | <0.2 |
| F | <2 | Fe | 0.17 | Mo | <0.5 | Pr | <0.3 | Re | <0.1 |
| Na | <1 | Co | <0.1 | Ru | <0.1 | Nd | <0.3 | Os | <0.1 |
| Mg | 4.5 | Ni | <0.2 | Rh | <0.1 | Sm | <0.3 | Ir | <0.1 |
| Al | 0.16 | Cu | 5.7 | Pd | <0.7 | Eu | <3 | Pt | <0.2 |
| Si | 15 | Zn | 20 | Ag | <5 | Gd | <0.3 | Au | <2 |
| P | Matrix | Ga | 30 | Cd | <5 | Tb | <0.1 | Hg | <0.5 |
| S | 48 | Ge | <1 | In | Matrix | Dy | <0.3 | Tl | <0.1 |
| Cl | 3.1 | As | 30 | Sn | <1 | Ho | <0.1 | Pb | <0.1 |
| K | <2 | Se | <3 | Sb | <0.3 | Er | <0.3 | Bi | <0.1 |
| Ca | <5 | Br | <5 | Te | <0.3 | Tm | <0.1 | Th | <0.05 |
| Sc | <0.1 | Rb | <0.1 | I | <0.1 | Yb | <0.3 | U | <0.05 |
| Ti | <0.1 | Sr | <0.1 | Cs | <5 | Lu | < | | |

Note:
*ion source material

Therefore, with the vaporized group V element (e.g., phosphorus or arsenic) in the vacuum and the high-temperature group III element (e.g., indium or gallium), the synthesis reaction of the molten mass can be rapidly generated and completed. In addition, the present invention provides multiple heating units to respectively control the temperature of different zones and additional heating units to protect and assist the temperature control, thereby facilitating the process of the compound synthesis. The present invention provides four sets of independent heating units 21, 22, 23 and 24 as a basic design mode. In other embodiments, six sets of independent heating units 21, 22, 23 and 24 is used, capable of increasing the precision of the temperature control, synthesis yield rate and synthesis resultant.

In comparison with the current skills, the vertical high temperature and high pressure stove structure of the present invention is capable of providing the synthesis growth temperature greater than the melting temperature of indium phosphide, operating in the high pressure environment, using direct fusion as synthesis mechanism to replace diffusion methods, and increasing the synthesis rate to prevent silicon contamination and the group III-V compound (e.g., indium phosphide) polycrystalline of rich group III element (e.g., indium). Due to free of problems caused by mobile rate of the crucible, the present invention can provide a preferred synthesis mixture proportion and free of silicon contamination according the testing results. Further, due to precise usage quantity of the group V element (e.g., phosphorus) in the synthesis process of the present invention, it is cost-effective and suitable of providing optimistic feeding pattern in the single crystal growth method.

What is claimed is:

1. A vertical high temperature and high pressure stove structure at least comprising a pressure vessel vertically disposed on a land surface and a heating module disposed in the pressure vessel, the heating module including a heating space filled with a quartz tube and at least four sets of independent heating units corresponding to the heating space, the at least four sets of independent heating units of the heating module being bottom-up sequentially defined as a first protective zone heating unit, a provision zone heating unit, a synthesis zone heating unit and a second protective zone heating unit;
wherein, in the vertical high temperature and high pressure stove structure, the synthesis zone heating unit of the heating module provides a group III element fusion zone with a temperature equal to or greater than that of a composition melting point, the provision zone heating unit of the heating module provides a steam having temperature greater than evaporation temperature to a group V element provision zone, and a compound synthesis of a group III element and a group V element as chemical element periodic table is rapidly completed in the group III element fusion zone.

2. The vertical high temperature and high pressure stove structure as claimed in claim 1, wherein the vertical high temperature and high pressure stove structure is utilized to synthesize gallium arsenide, gallium phosphide or indium phosphide.

3. The vertical high temperature and high pressure stove structure as claimed in claim 1, wherein the pressure vessel comprises a vessel main body provided with an upwardly-formed opening and a top end disposed with a selectively-closed vessel cover body.

4. The vertical high temperature and high pressure stove structure as claimed in claim 3, wherein the vessel main body of the pressure vessel is disposed on the land surface by a supporting frame.

5. The vertical high temperature and high pressure stove structure as claimed in claim 1, wherein the heating space of the heating module has an opening disposed with a core cover body of selectable opening or closing.

6. The vertical high temperature and high pressure stove structure as claimed in claim 1, wherein if the amount of the heating units of the heating module is greater than four, the amount of the provision zone heating unit and the amount of the synthesis zone heating unit are multiply increased in proportion to the amount of the heating units of the heating module so as to form six or eight sets of independent heating units to increase precision and stability of temperature control of the group III element fusion zone and the group V element provision zone.

7. The vertical high temperature and high pressure stove structure as claimed in claim 1, wherein the pressure vessel and the heating module are connected to a control module, the control module includes a power cord connected to the heating module disposed in the pressure vessel, a temperature control signal line and a high pressure pipe utilized to fill a high pressure gas in the pressure vessel, and the control module is provided to control the pressure of the pressure vessel and the temperature of the heating module according to the requirement of a compound synthesis flow process.
